(19) United States
(12) Patent Application Publication
(10) Pub. No.: US 2025/0216999 A1
(43) Pub. Date: Jul. 3, 2025

(54) METHODS AND SYSTEMS OF PROVIDING A SCREEN AS A SERVICE PLATFORM

(71) Applicant: GALVION LTD., Portsmouth, NH (US)

(72) Inventor: Jonathan ANDREE, Bedford, NH (US)

(73) Assignee: GALVION LTD., Portsmouth, NH (US)

(21) Appl. No.: 19/003,244

(22) Filed: Dec. 27, 2024

Related U.S. Application Data
(60) Provisional application No. 63/615,602, filed on Dec. 28, 2023.

(51) Int. Cl. G06F 3/0481; G06F 3/0484; G06F 3/14

(52) U.S. Cl. CPC G06F 3/0481; G06F 3/0484; G06F 3/1454

(57) ABSTRACT

A screen as a service platform provides a common interface between a user and a plurality of data source endpoints. The common interface allows the data source endpoints to efficiently source data to a user via a shared display. The system includes one or more data source endpoints, a network, a display device, and a screen as a service (SaS) engine. The screen as a service (SaS) engine provides a uniform platform to integrate data source endpoints into a system and to aggregate and manage data produced by the data source endpoints.

### CROSS REFERENCE TO RELATED APPLICATIONS

This application claims the benefit of priority of U.S. Provisional Application No. 63/615,602 filed on Dec. 28, 2023, the disclosure of which is incorporated herein by reference in its entirety.

### FIELD OF THE INVENTION

The subject technology described herein includes a screen as a service platform useful for providing a common interface to allow heterogeneous devices connected to a human-to-machine interface system, for example a visual augmentation system (VAS), to communicate with a user by providing data to a user on an output device such as a shared display.

In general, a human-machine interface system includes different components that source useful data to a user. In an exemplary VAS-based human-machine interface system the data includes information that is processed by a computing sub-system in the VAS and is provided to the user visually via a display, for example a display screen of a head-worn heads-up display (HUD) device or a display screen of an end user device (EUD), e.g., a smartphone or tablet.

### SUMMARY OF THE INVENTION

In a VAS, each system component that provides data to be shown on a display is typically designed to interact with a specific display and requires a specific application or plugin to process its sourced data. A VAS usually has limited resources, such as physical space, power, and computing capabilities, and thus it is difficult for a VAS to manage a growing set of applications for a scalable system. Hence, it is desired to provide a common interface to resourcefully integrate components in the VAS to communicate with a user. The technology described herein enables solutions to a number of problems that have not been previously solved including, but not limited to, a need to efficiently communicate data to a user from multiple sources in a human-machine interface system.

In embodiments, the system aggregates data from multiple data sources and determines what and how to communicate the data to a user via one or more data output devices, for example how to display data on various displays or communicate audible data using various speakers. In some embodiments, the system determines how to communicate the data to the user based on pre-configured templates and rules. In some embodiments, the system determines what and how to communicate data to the user via various data output devices with input from a user and/or event triggers.

The technology disclosed herein can minimize the cognitive load on a user by enabling a flexible system that communicates data and provides user interaction, with as much consistent capability, regardless of what device the user interacts with at a moment, or decides to carry or power. The system provides the user with information that allows the user to make decisions based on the current task and unforeseen impediments (for example hostiles, environment, unplanned events, resources like low power).

The above and other features of the technology including various novel details of construction and combinations of parts, and other advantages, will now be more particularly described with reference to the accompanying drawings and pointed out in the claims. It will be understood that the particular method and device embodying the technology are shown by way of illustration and not as a limitation of the technology. The principles and features of this technology may be employed in various and numerous embodiments without departing from the scope of the technology.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the technology. The features of the present technology will best be understood from a detailed description of the technology and example embodiments thereof selected for the purposes of illustration and shown in the accompanying drawings in which:

FIG. 1 depicts an exemplary schematic diagram of a system according to the technology disclosed herein;

FIG. 2A depicts an exemplary block diagram of an asynchronous integration process according to technology disclosed herein;

FIG. 2B depicts an exemplary block diagram of a two-way integration process according to technology disclosed herein;

FIG. 2C depicts an exemplary schematic diagram of a SAS AR compute platform according to the technology disclosed herein;

FIG. 3A depicts an exemplary schematic diagram of a SAS AR compute platform according to the technology disclosed herein;

FIG. 3B depicts an exemplary schematic diagram of an end user device according to the technology disclosed herein;

FIG. 4 depicts multiple predefined screen layouts according to the technology disclosed herein;

FIG. 5 depicts an exemplary illustration of a user interface for selecting screen content and layout according to the technology disclosed herein;

FIG. 6 depicts an exemplary illustration of screen content from one or more data source endpoints collectively displayed on a display screen according to the technology disclosed herein;

FIG. 7 depicts an exemplary illustration of a screen for a data source endpoint including a custom menu as a data service according to the technology disclosed herein;

FIG. 8 depicts an exemplary illustration of screen content from one or more data source endpoints collectively displayed on a display screen according to the technology disclosed herein;

FIG. 9 depicts an exemplary illustration of a data flow in a screen as a service platform according to the technology disclosed herein;

FIG. 10 is a process flow describing a method of operation of the SAS AR compute platform according to the technology disclosed herein.

### DETAILED DESCRIPTION

As used herein, the term “and/or” includes any and all combinations of one or more of the associated listed items. Further, the singular forms of the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence of addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

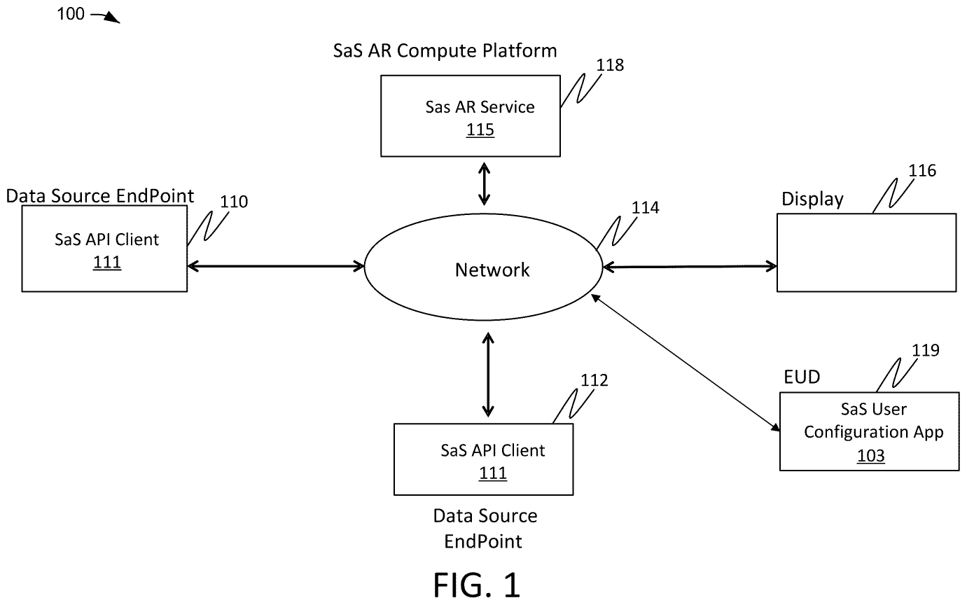

Referring to FIG. 1, an example system 100 comprising an illustrative architecture for providing a screen as a service (SaS) platform is shown. The system provides a common interface between a user and a plurality of data source endpoints (i.e., endpoints). The common interface allows the data source endpoints to efficiently source data to a user via a shared display. The common interface also allows a user to interact with and to change one or more operational attributes of the data source endpoints by interacting with the shared display.

The system 100 includes one or more data source endpoints 110 and 112, network 114, display device 116, which includes at least one screen for displaying information, and a screen as a service (SaS) AR compute platform 118, including SaS AR service 115. In some embodiments, the system may include an end user device (EUD) 119 including a SaS user configuration App 103. The system 100 is scalable and although the disclosed embodiment shows data source endpoint 110 and data source endpoint 112, any number of data source endpoints may be included in the system. Moreover, any number of displays 116 and networks 114 may also be included in the system.

Data source endpoints 110, 112 may be implemented as any hardware or software component that produces data for display, such as, for example, an internet of things (IoT) device, mobile device, a tablet, a compass, a thermal scope, a virtual keyboard, a laptop device, an application, and/or any other computing component. Each data source endpoint 110, 112 is able to integrate with system 100 (including the SaS compute platform 118) through an integration process. Once integrated, a data source endpoint is able to use the SaS platform, and the SaS AR compute platform 118 generates, based on information corresponding to each data source endpoint, data to be displayed on one or more screens of one or more display devices 116 or in one or more windows on display screens of one or more display devices 116. In some embodiments, a user interacts with the SaS user configuration app 103, operating on the EUD 119, to configure one or more aspects of display of information on the one or more display devices 116.

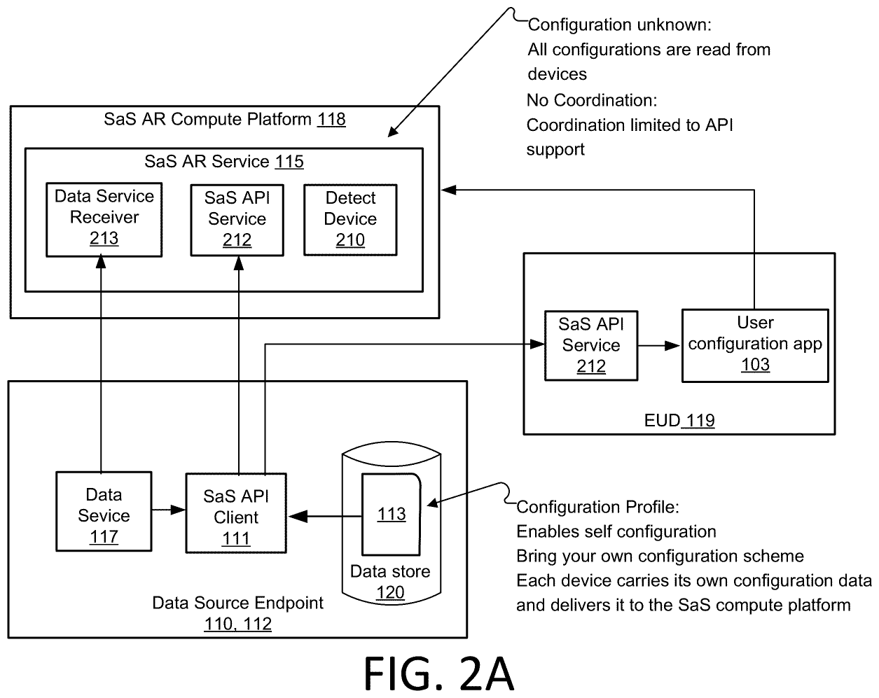

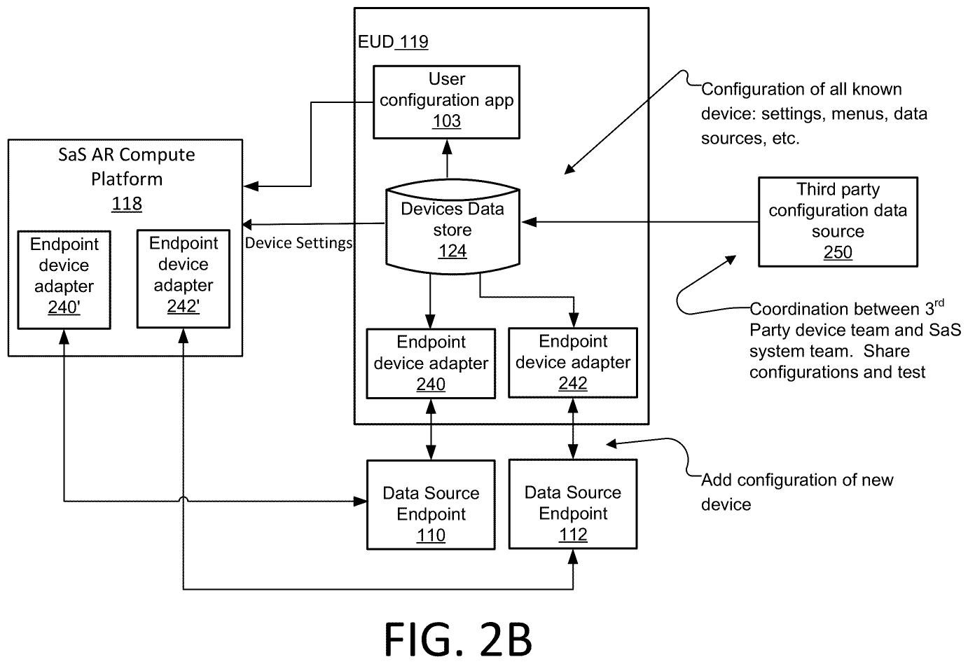

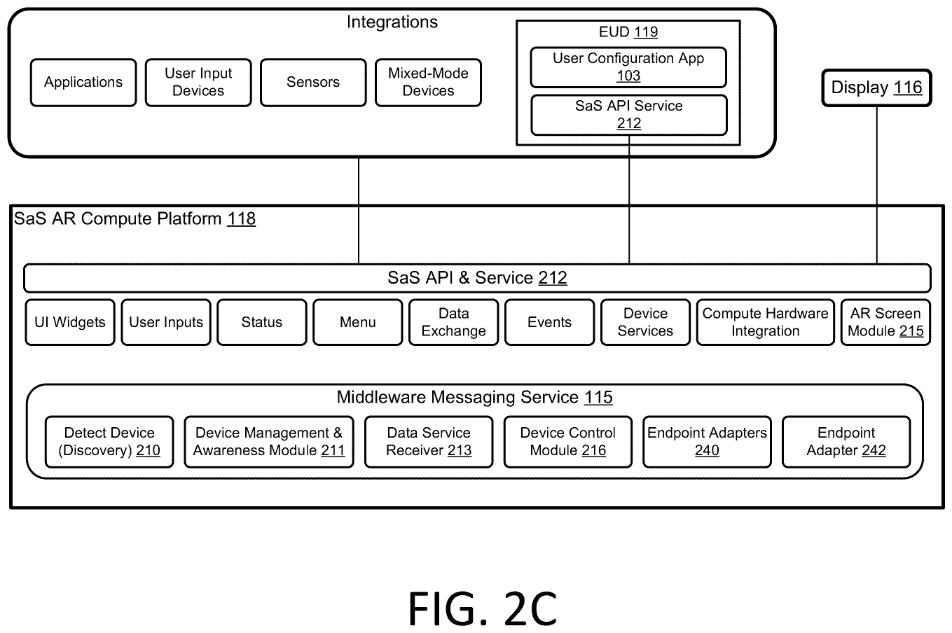

In some embodiments, integration of data source endpoints 110, 112 with system 100 may be implemented using an asynchronous (i.e., one-way) integration process, as shown in FIG. 2A. In this implementation, to integrate with the system 100, each data source endpoint interfaces directly with the SaS AR compute platform 118, and in some embodiment with the EUD 119, or with another device that includes an instance of the user configuration app 103. Further, a SaS API is published to device makers, for example via a SaS API client 111. A device maker can include the SaS API client 111 with their device software and can develop their own device software to conform to the SaS API. The SaS API client 111 interfaces with SaS AR service 115, in particular the SaS API client 111 interacts with an API services module 112 included in the SaS AR service 115, and with an SaS API services module 112 of the EUD 119. In this manner, endpoint devices are enabled to communicate information to the SaS AR compute platform 118 and EUD 119 using the SaS API. Any data source endpoint comprising software configured to conform to the SaS API is considered SaS enabled. The system 100 does not need to be modified ahead of time (i.e., pre-programmed with information corresponding to data source endpoint devices) to integrate a data source endpoint. So long as the device maker software conforms to the SaS API, the data source endpoint will be able to integrate into the system seamlessly.

In embodiments, the data source endpoints 110, 112 may each store one or more configuration profiles 113 in a data store 120 of the data source endpoint. A configuration profile 113 is typically generated by a data source endpoint provider, for example a third-party that manufactures and/or configures the data source endpoint. A configuration profile 113 includes information corresponding to a particular data source endpoint (e.g., 110 or 112) that may be needed by the AR compute platform 118 and/or the EUD 119 to configure the SaS system 100 for receiving, processing, and displaying information provided by the data source endpoint on one or more display devices 116. A configuration profile can include device settings information, e.g., information identifying one or more user-configurable device settings, menu definition information, e.g., information that defines one or more selectable menu items corresponding to the device, and device capabilities information that, for example, identifies characteristics of one or more data services 117 available from the device.

A data service 117 publishes information generated by the endpoint device 110, 112, for example a video feed in the case where the endpoint device includes a video camera or an audio feed in the case where in the endpoint device includes a microphone or radio configured for receiving or generating audio information. Device capabilities information may include, for example, a resolution, in pixels, of the video feed, preferred display colors, frame rate, etc. In general, device capabilities information may include any information that the SaS AR compute platform 118 may require to process, and format for display or for another presentation modality, data that it receives from one or more data services 117.

The configuration profile 113 may be loaded onto the data source endpoint, and in some embodiments updated after initial provision, by the data source endpoint provider, by a user, or by another provisioning entity or service.

In an example, the SaS API client 111 is operated by a data source endpoint 110 or 112 to communicate one or more configuration profiles 113 to the SAS AR compute platform 118. The SaS AR compute platform 118 can operate the SaS AR service 115, for example an API Service module 212 of the SaS AR service 115, to receive information from a data service 117 of data source endpoint. The SaS AR compute platform 118 can operate the SaS AR service 115 to control and/or change and operating characteristic of the data source endpoint based at least upon information contained in a configuration profile 113 that it receives from the data source endpoint.

In a like manner, the SaS API client 111 is operated by the data source endpoint to communicate one or more configuration profiles 113 to the EUD 119. A user can interact with the user configuration app 103 to generate display configuration settings, based at least upon information contained in one or more configuration profiles 113. In embodiments, the display configuration settings are encoded in a screen specification that specifies characteristics of a screen used to display information, for example what information from one or more endpoint devices, e.g., 110 or 112, should be displayed on the display device 116 and how that information should be displayed.

Turning to FIG. 2C, a SaS API (e.g., a SaS client) may be integrated with a set of Application Hosting Services as illustrated in FIG. 2C. The APIs provide access to the internal tools used by the SaS platform, enabling 3rd party developers to install software packages into the SaS as a plug-in model. With the SaS Compute Platform, the SaS can be extended by software leveraging the Application Hosting Services to integrate more fully into the system and provide a consistent functional interface to the user.

The APIs may be called directly by software installed on the SaS AR Compute Platform, or remotely through a connected end user device (EUD). The API on an EUD includes a remote transfer service to send API commands between the EUD and connected SaS AR Compute Platform.

### Services

UI Widgets Service—Enables definition of screen widgets that work within the layout manager to display content.
User Input Service—Manages human input devices of different designs and maps the inputs to events that all software can receive and respond to
Status Service—Presents a common interface for status and alerts from the system, regardless of what software is operating in the foreground.
Menu Service—Integrates with User Input Service to display menus on screen and accept user input.
Data Exchange Service—Extends middleware messaging services to route data between subsystems and installed software.
Event Services—Extends middleware messaging to manages the API events between all platform services and installed software.
Device Services—Leverages middleware device discovery and integration layer to abstract devices into callable data sources.
Compute Hardware Integration Services—Exposes lower-level features built-into the compute hardware through an abstraction layer.
AR Screen Module—The primary service for pushing content to a display.

The EUD 119 communicates the screen specifications, including display configuration settings, to the SaS AR platform 118, which uses the information to determine how to process and format, for display, information that the SaS AR services receives from one or more endpoint devices. When the system 100 is operating, one or more data services 117, each operating on a data source endpoint, e.g., 110 or 112, communicate data to the SaS AR compute platform 118. The data from the data service 117 is received by a data services receiver module 213 of the SaS AR Service 115 and is further processed to generate information to be displayed on one or more display devices 116, in accordance with display configuration settings of a screen specification received from the EUD 119.

In an alternative embodiment, the SaS AR compute platform 118 may include an instance of the user configuration app 103 or may include components of the user configuration app 103 for generating display configuration settings and the EUD 119 may not be necessary. In still further exemplary embodiments, the user configuration app 103 can be operated on a network device other than the EUD 119, for example on a laptop computer, tablet device, watch, or any other suitable device that includes a processor and a user interface for supporting interaction of a user with the user configuration app 103.

Prior to receiving one or more configuration profiles 113 from one or more data source endpoints, e.g., 110, 112, the configurations of the data source endpoints may be unknown to the SaS AR compute platform 118. Advantageously, the SaS AR compute platform 118 need not be pre-configured with information corresponding to the data source endpoints 110, 112 and can instead be provisioned with all information that it requires to interact with a particular data source endpoint via the one or more configuration profiles 113 that it receives from the data source endpoint.

In this manner, the SaS AR compute platform 118, and the operation of the system 100 in general, does not require coordination with third party providers of data source endpoint devices, other than requiring that the third parties implement the SaS API client 100, for example by configuring their third-party devices with configuration profiles 113 that conforms to requirements of the API.

In some exemplary embodiments, the system 100 (via SaS AR compute platform 118) can be configured to probe each data source endpoint 110, 112 (e.g., via a dynamic device discovery process). The system 100 can further use the dynamic device discovery process to determine whether a discovered device is SaS compliant (i.e., SaS enabled). If the system 100 determines that a data source endpoint, e.g., 100 or 112, is SaS compliant, the SaS AR compute platform 118 can receive, via the SaS API, one or more configuration profiles 113 from the data source endpoint and determine one or more device settings and/or one or more data services offered or accepted by the data source endpoint. The SaS AR compute platform 118 or EUD 119 may display the settings to a user and send any desired changes communicated to the SaS AR platform by the user back to the data source endpoint.

In some embodiments, the SaS AR compute platform 118 may probe a data source endpoint to determine the one or more settings and/or the one or more data services offered or accepted by the data source endpoint. For example, the SaS AR compute platform 118 may provide one or more questions to the data source endpoint, such as, for example, one or more of: “Do you provide menus?”; “Do you provide settings?”; “Do you provide audio?”; “Do you provide video?”; or “Do you provide sensor data?”. In this instance, the SaS AR compute platform collects all the response data, presents options to user (e.g., video source brightness, layout options), and the user makes selections for the options presented (user-customization).

In a preferred implementation, each SaS enabled data source endpoint 110, 112 is configured to integrate with the system 100 using a dynamic discovery process and SaS API client 111. Data source endpoint device integration using a SaS API client 111 can be referred to as API-compliant integration.

In an example embodiment, the SaS AR compute platform 118 operates a detect device module 210 to implement a device discovery process, for example a device discovery process, e.g., according to a USB device discovery protocol. In other embodiments the system may use one or more discovery processes, for example an intra-soldier wireless network (ISW) or Bluetooth discovery process. In still further embodiments, the system may discover the presence of an endpoint devices on the network 114 by receiving a communication message, for example a middleware formatted message, from the endpoint device that includes a device identifier.

The SaS AR compute platform 118, or in some embodiments a compute subsystem upon which the SAS AR compute platform operates, may establish a communication session with a discovered data source endpoint. The SaS API client 111 communicates one or more configuration profiles 113 to the API and Service module 212, operating on the SaS AR compute platform 118.

Once integrated (e.g., using API-compliant integration), the SaS AR compute platform 118 dynamically generates one or more screens (i.e., screen designs or screen layouts) for each data source endpoint 110, 112 or for one or more combinations of data source endpoints based on information, e.g., one or more configuration profiles 113, received from the SaS API client 110 operating on the data source endpoint. The one or more screens may correspond to the data source endpoint device settings and/or one or more data services 117 offered or accepted.

In embodiments, a user interacts with the user configuration app 103, operating on the EUD 119, to define one or more screen specifications and the EUD communicates the one or more screen specifications to the SaS AR compute platform 118, which uses the screen specification to generate screens to be presented by a display device 116. The generated screen specifications may be stored in a screen specification store (i.e., data storage device) for retrieval when data content is received from a corresponding data source endpoint.

During operation of the system 100, one or more data services 117 of one or more source endpoints (e.g., 110, 112) generate data and provide the data to the SaS AR compute platform 118, either via SaS API client 111 or through another messaging protocol, for example by generating one or more data messages that are compliant with a legacy or proprietary messaging protocol and communicating the messages over the network 114. The SaS AR compute platform 118 generates image feed data, e.g. one or more screens, for presentation on one or more displays 116 (i.e., generates one or more screens to be displayed, each including one or more windows) based on data received from the one or more data sources and based upon a screen specification that includes specification of how the received data should be presented on the one or more displays 116.

A major advantage of the asynchronous integration process is the SAS AR compute platform 118 does not need to be pre-programmed. Accordingly, if any of the device settings or data services for a data source endpoint change (e.g., due to upgrades), the SaS AR compute platform 118 does not need to be re-programmed by a user. Instead, the device software (i.e., on the endpoint device), that is configured to conform to the SaS API client 111, is updated based on the changed device settings or data services, for example by a third party that provides the endpoint device and updates its settings and data services. In an example embodiment, the third party updates the device software by updating one or more configuration files 113 that are stored on the third-party device and provided to the SaS AR compute platform 118 by the SaS API client 111. The SaS AR compute platform 118 is informed of the change(s) dynamically, for example by the device software communicating an updated configuration profile via the SaS API client 111, and makes any adjustments to the one or more screens, as necessary. The device itself is updated to carry the correct settings and provide the updated settings to SaS AR compute platform 118 dynamically. For example, a third party may communicate one or more updated configuration profiles 113 to the device or prompt a user to load updated configuration profiles onto the device.

In some embodiments, integration of the data source endpoints with system 100 (i.e., with SaS AR compute platform 118) may be implemented using a coordinated non-API integration process, as illustrated in FIG. 2B. The coordinated non-API integration process can be used to integrate data source endpoint clients that are not API-compliant, i.e. that do not include software that is compliant with the SaS API for communicating device profiled 113 from the device to the system. The coordinated non-API integration process requires preprogramming and coordination between third party device providers and operators of the system 100 to pre-configure the system with information corresponding to the non-API compliant data source endpoint devices.

A facilitator 119 can be pre-configured to interact with non-API compliant devices. In some embodiments, an EUD is configured as a facilitator while in other embodiments, a SaS AR compute platform 118 can be operated to carry out the functions of a facilitator. In some embodiments, the facilitator 119 includes one or more endpoint device adapters 240, 242, each corresponding to a particular endpoint device or type of endpoint device. It is understood that although two endpoint device adapters 240 and 242 are shown, the facilitator 119 can include more or fewer endpoint device adapter, for example the facilitator 119 can include an endpoint device adapter for each endpoint device that may be connected to the system. The endpoint device adapters each include instructions that when executed by one or more microprocessors of the facilitator 119, cause the one or more microprocessors to communicate with an endpoint device and to retrieve data from the endpoint device. An endpoint adapter 240, 242 is typically pre-configured to include details corresponding to an endpoint device including information on how to send data to and receive data from the endpoint device.

The endpoint device adapters 240, 242 can include information required by the facilitator 119 to receive data from a data service of a corresponding endpoint device, which the facilitator can forward to the SaS AR computer module 118 in some embodiments. The endpoint device adapters can further include information required to send control commands to an endpoint device, for example in response to receiving user input. In some embodiments, an endpoint device adapter is pre-configured with device characteristics information, for example one or more configuration profiles 113. For example, an endpoint adapter 240 or 242 can be configured with an endpoint device-specific data specification that enables the endpoint adapter to make data retrieval calls or to send control messages to the endpoint device. In an example embodiment, an endpoint adapter (e.g. 240, 242) is configured to interact with an endpoint device (e.g. 110, 112) with an inter-device communication scheme used by the endpoint device over a communication protocol used by the endpoint device. In this example embodiment, a third-party configuration data source (e.g. 250) can coordinate with on implementer of the system 100 to provide information used by the implementer to configure endpoint adapters (e.g., 240, 242). The information provided by the third-party configuration data source 250 can include, for example an inter-device communication scheme used by an endpoint device, specific commands that the endpoint device is configured to respond to, and a communication protocol to use with the endpoint device.

In some embodiments, a SaS AR compute platform 118 is configured with one or more endpoint adapters, e.g. 240′ and 242′ which can receive information directly from one or more endpoint devices 110, 112, for example data generated by a data service of the endpoint device. The endpoint adapters 240′ and 242′ further enable the SaS AR compute platform 118 to communicate device commands and/or settings instructions to one or more endpoint devices, e.g. 110 and/or 112. The endpoint adapters 240′ and 242′ of the SaS AR compute platform 118 are configured and are operable similarly to endpoint adapters 240 and 242 of the facilitator 119.

In a further exemplary embodiment, the endpoint adapters, e.g. one or more or 240, 240′, 242, and 242′, are configured to enable to the facilitator 119, and/or the SaS AR compute platform 118, to communicate with one or more endpoint devices and to receive data from endpoint devices that includes one or more operating characteristics, devices settings, and/or menu settings associated with the endpoint device, for example one or more configuration profiles 113. In this embodiment, the facilitator 119 (and/or SaS compute platform 118) is provisioned, via the endpoint device adapters, with information that it needs for further communication with endpoint devices, including, for example, data services available on the endpoint devices and menu settings. The facilitator 119 and/or SaS AR compute platform 118 operates the one or more endpoint device adapters to interface with the data source endpoints. The data source endpoints will provide their device settings and/or data services offered or accepted to the facilitator 119 and/or SaS AR compute platform 118. In this manner, a data endpoint device, e.g. 110 or 112, that is not API-compliant can be configured to dynamically provide device-specific configuration information, e.g. a configuration profile 113, to the system as long as the system includes an endpoint adapter (e.g. 240, 240′, 242, or 242′) that is pre-configured to communicate with the endpoint device and retrieve the configuration information from the endpoint device.

In an example embodiment, each data source endpoint 110, 112 interfaces directly with a facilitator endpoint (e.g., EUD 119 and/or SaS AR compute platform 118), such as, for example, a smart mobile device, which integrates with the system 100. The facilitator end point (“facilitator”) includes SaS User Configuration App 103 which interfaces with SAS AR compute platform 118 to communicate configuration information to the SaS AR compute platform 118.

The SaS User Configuration App 103 allows an end user to interface with SaS AR compute platform 118, for example by interacting with the facilitator endpoint (e.g., 119) to define one or more screen layouts for the SaS AR compute platform to use when formatting data for display on a screen and to configure one or more actions that the AR compute platform may enable in response to detecting a button press. Moreover, in some exemplary embodiments, the facilitator includes an interface app 103 for each data source endpoint that allows the facilitator to interact with the respective data source endpoint.

Any data source endpoint that includes any one of the SaS User Configuration App 103 or SaS API client 111, or that is controlled by/interfaces with a facilitator is a SaS enabled device.

The coordinated non-API integration process requires preprogramming and requires two parties to coordinate sharing documents and specifications on how to integrate and test. So, for example, before integration, a device (e.g., a data source endpoint 110) maker may share with an application developer (e.g., an application developer for an application running on SaS AR compute platform 118, for example, SaS AR service 115) what settings the device has and/or what data services are offered or accepted by the device.

In a first example implementation of a coordinated non-API integration process, previously discussed, a third-party endpoint device provider communicates device-specific information to an implementer of the system 100. The system implementor uses the information received from the third-party provider to generate one or more device-specific endpoint adapters (e.g. 240, 242, 240′, 242′). The system implementor can configure one or more facilitators, e.g. EUD 119 and/or SaS AR compute platform 118, with the device-specific endpoint adapters, thereby pre-configuring the facilitators to communicate with data source endpoint devices.

In a second example implementation of a coordinated non-API integration process, a third-party configuration data source 250 may communicate one or more configuration profiles 113, each corresponding to a particular third-party device, to the facilitator 119. The facilitator 119 stores device configuration profiles in one or more device data stores 124. In some embodiments, an application developer can create/generate screen specifications (i.e., screen designs) for the settings/services prior to integration (pre-programming) and store the screen specifications in a data store 124 integrated with the EUD 119. In other embodiments, a user can interact with the user configuration app 103 to define or modify one or more screen specifications based at least upon information included in one or more configuration profiles 113 that have been stored in the device data store 124 by the application developer.

The facilitator 119 will store the information provided directly by the endpoint devices with the endpoint device adapters, e.g. 240 and 242, and information provisioned by application developer(s), e.g., provided by third party configuration data source 250, in the data store 124 and will provide the information along with data source endpoint identification information to the SAS AR compute platform 118. In some embodiments, the facilitator 119 may provide the information to the SaS AR compute platform 118 once it interfaces with the SAS AR compute platform 118. In some embodiments, if the facilitator 119 is already interfaced with the SAS AR compute platform 118, the facilitator may provide the information to the SAS AR compute platform upon interfacing with a data source endpoint or upon receiving configuration information from a third part configuration data source 250. In this manner, the system 100 can be provisioned with endpoint device information using an API-compliant integration process (as shown in FIG. 2A), with a non-API configuration process (e.g., with a legacy configuration process), or with a hybrid process that includes API-compliant integration for API-compliant endpoints and legacy integration for non-API compliant endpoints.

For a coordinated non-API integration process, whenever changes are made to a data source endpoint's device settings and/or services, device configuration settings stored the devices data store 124 are updated by one or more of the third-party configuration data source 250 or by an endpoint device adapter (e.g., 240, 242) communicating with and endpoint device to retrieve updated configuration settings from the device. In addition, the SaS AR service 115 in SaS AR compute platform 118 may require to be re-programmed to generate new screen specifications accordingly. The reprogramming may require the user to interact with the user configuration app 103 operating on the EUD 119 and/or may require the third-party configuration data source 250 to provide updated screen specifications.

Once integrated (using the coordinated non-API integration process), the facilitator 119 may act as coordinator of data between each data source endpoint, e.g., 110, 112, and SaS AR compute platform 118. In this implementation, each data source endpoint provides data content to the facilitator for transmission to SaS AR compute platform 118 for presentation on display 116. The facilitator 119 coordinates the data with SaS AR compute platform 118 using SaS User Configuration App 103. In other implementations, data source endpoints may communicate data generated by one or more data services 117 to the SaS AR compute platform 118 directly, e.g., according to one or more networking message protocols, or via an API client 111 (see FIG. 2A).

Once integration is complete either by API-compliant integration, as illustrated, for example, in FIG. 2A, or by coordinated non-API-compliant integration, as illustrated, for example, in FIG. 2B, the SaS AR compute platform 118 acts as a coordinator of data between each integrated data source endpoint 110, 112 and/or facilitator 119 and display 116. Each data source endpoint 110, 112 sources data content for one or more data services 117 (e.g., video, GPS) having one or more formats (e.g., MPEG-4, map coordinates) to the SAS AR compute platform 118 using one or more of: direct communication to a data service receiver 213 (see FIG. 2A); SaS API client 111; or endpoint device adapter (e.g., 140, 142) of a facilitator (e.g., 118 or 119). The sourced data content will be communicated to an end user visually by way of one or more screens using display 116. As data becomes available from a particular data source endpoint, the data source endpoint or facilitator 119 sends the data to the SAS AR compute platform 118, and the SAS AR compute platform displays the content using one or more screen layouts generated for the data source endpoint or for two or more data source endpoints.

Network 114 may include one or more networks, such as, for example, any one or a combination of multiple different types of networks, such as USB networks, intra-soldier wireless (ISW) network, Bluetooth (BT) network, the Internet, wireless networks, and other private and/or public networks. In some instances, the network may include cellular, Wi-Fi, or Wi-Fi direct. Further, the one or more networks may include a personal area network (PAN), a local area network (LAN) or wide area network (WAN) (e.g., the Internet or a private military WAN) or any other suitable network for the transmitting of data from a source to a destination. Network 114 may include a localized network of physically connected devices or a personal area network (PAN), an internet or radio network.

Display 116 may include one or more display devices, such as, for example, any one or a combination of multiple different types of display devices, such as, for example, a heads-up display (HUD), a smart scope, an end user device (EUD) (e.g., a smart phone), night vision goggles enhanced with augmented reality, and a wrist worn display (e.g., a watch). Each display device has a specific screen form factor and thus each display device requires a different configuration for displaying data and thus may require a separate screen specification (i.e., screen layout) to be configured for each display device. In some embodiments, the system 100 may include multiple displays (i.e., display devices) which are interchangeable and/or that may be in use concurrently. For example, in some embodiments, the same data may be concurrently displayed to a HUD, weapon-mounted scope, End User Device (EUD/Phone), and a watch. In this manner, the system is enabled to relieve the user of the burden of selecting the proper display device for a task by making the same data and same options available regardless of how the user is interacting with the system of systems, i.e., regardless of what particular display of what particular device the user is currently interacting with. The user may be looking at a HUD while viewing a battlefield, or using a weapon scope to monitor a target. In either case the user can access the same data.

It is notable that a particular display device 116 may include a data source, for example a data service 117, that generates information for display on a screen 116 of the particular display 116 and one or more additional displays. For example, a weapon-mounted scope may include an imaging device capable of capturing video data that is made available to the system 100 by a video data service of the scope. In this manner, the scope is enabled to push data to the system 100. The scope also includes a display that can be used to show, to a user, information that is communicated to the scope by the system 100, for example information encoded in a scope-specific screen layout and communicated to the scope from the SaS AR compute platform 118. In this manner, any device that includes both a display, or screen, and a source of data can push data to the system 100, e.g., to be displayed on a screen of a different device, for example on a HUD screen, and receive data to the system 100.

Further, in some embodiments, the system 100 may include one or more input sources (e.g., soft buttons/touch panel, hard buttons, a microphone, a scroll wheel, an input received at a network interface, an input from an application, etc.), from which the system is able to receive inputs from an end user. In some embodiments, an input source may include devices/applications that are connected to, but not included as part of the system. In some embodiments, an input received from an input source may initiate the SAS AR compute platform 118 to display one or more screens or to alter a currently implemented screen layout, for example to show a new window or a menu in response to a button push.

The screen as a SaS AR compute platform 118 provides a uniform platform to integrate data source endpoints into a system (e.g., VAS or PAN) and to manage data produced by the data source endpoints. The SAS AR compute platform 118 is responsible for interpreting messages, brokering messages to the correct processes and devices, and for displaying one or more screen layouts containing content sourced from a corresponding data source endpoint. The SAS AR compute platform 118 allows each data source endpoint to seamlessly transmit data to a user via a display (e.g., display 116).

In some embodiments, the SAS AR compute platform 118 is integrated in a smart helmet, for example a helmet that is configured with a processing device that operates the SaS AR service application 115. In this and other embodiments, a data source endpoint can include an application running on the smart helmet, for example ML software that generates 3D imagery or classifies live scenes and/or objects, or a device integrated in or mounted on the smart helmet, for example an inertial measurement unit (IMU), visible light camera, infrared light sensor, microphone, or laser detection system.

In some embodiments the SAS AR compute platform 118 is integrated in a smart phone (e.g., Android), for example an EUD, or an edge network computing device, both of which can also include data source endpoints. Exemplary data source endpoints that may be including on an EUD include a text-to-chat application, an ATAK application and/or one or more ATAK plug ins, for example a source of ATAK map data, ATAK chat data, or data from a Jump plugin useful for a parachuting operation. Additional exemplary data source endpoints include ammunition counters and power meters, for example power tracking software.

In some embodiments, the SAS AR compute platform is integrated into a USB Hub (i.e., Smart Hub). In some embodiments, the SAS AR compute platform 118 is integrated in a smart phone as a device in the network separate from the SAS AR compute platform. The smart phone may be used for any combination of functions, such as, for example, a display, user input, data source, video source, audio source, and processing.

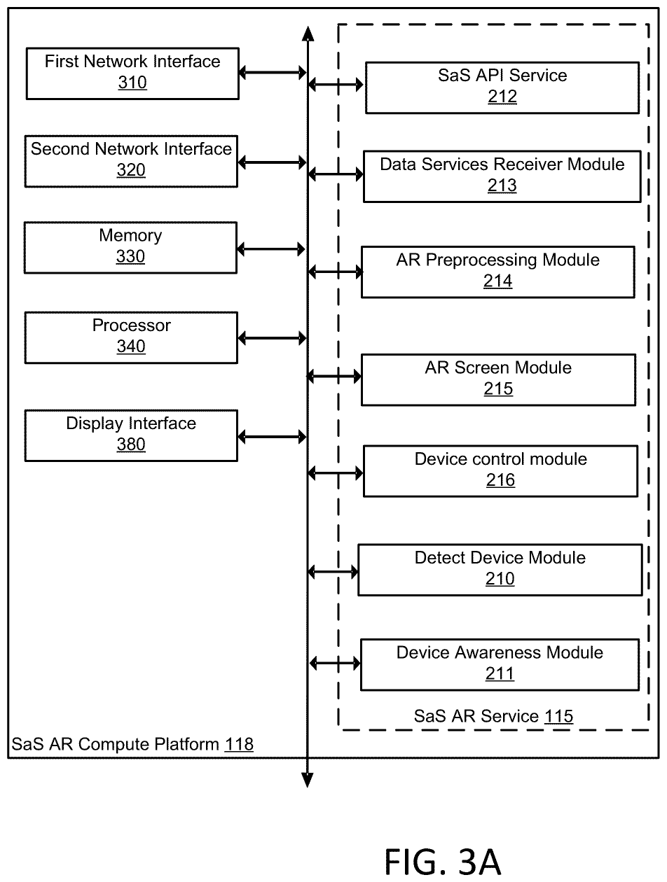

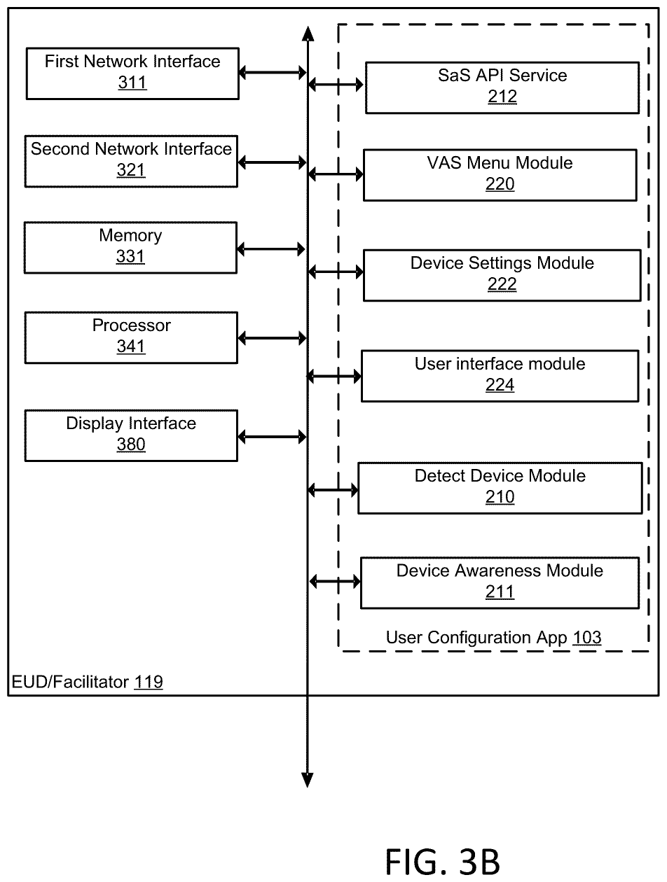

As shown in FIG. 3A, the SAS AR compute platform 118 includes a first network interface 310, a second network interface 320, a memory 330, a processor 340, a SaS AR service application 115 which includes SaS API service 212, data services receiver module 213, AR preprocessing module 214, AR screen creator module 215, display interface module 217, device control module 216, detect device module 210, and device awareness module 211.

The first network interface 310 can be configured to receive data from data source endpoints 110 and 112 via network 114. It should be understood that the first network interface 310 may include any interface configured to send and receive data from any component connected to the network 114.

The second network interface 320 can be configured to receive data from an application running on the platform in which the SAS AR compute platform 118 is integrated. It should be understood that the first network interface 310 may include any interface configured to send and receive data from any component connected to the network 114.

The memory 330 (e.g., one or more built in or removable data storage devices, random access memory (RAM), non-volatile secondary storage (i.e., persistent memory), hard drive, a floppy drive, and a CD-ROM drive) may include one or more data stores (e.g., memory which stores screen designs and screen layouts), frame buffers, and one or more databases (e.g., device settings and data services) and may store data, business logic rules, applications (e.g., SaS AR service application 115), and computer executable instructions.

Processor 340 is configured to control the operation of SAS AR compute platform 118. The processor 340 may include one or more microcontrollers, microprocessors, application specific processors, field programming gate array (FPGA) for managing multiple processes occurring within the SAS AR compute platform 118.

The data services receiver module 213 contains instructions that when executed by the one or more microprocessors 340, cause the one or more microprocessors to receive data (e.g., video, audio, application, or map data) via the first or second network interfaces 310, 320 from one or more data services 117, each operating on an data source endpoint device, or from one or more applications operating on the SaS AR compute platform 118, and to perform any processing of the received data necessary to extract or generate useful information, for example to extract video feed data and assemble a video feed from a plurality of network data packets.

The AR pre-processing module 214 contains instructions that when executed by the one or more microprocessors 340, cause the one or more microprocessors to operate on data received from one or more data services, for example to generate information for display one a display device. For example, the AR pre-processing module may be implemented to format video data for display. The AR screen module 350 in application 115 contains instructions that when executed by the one or more microprocessors 340, cause the one or more microprocessors to create/generate, based on one or more screen specifications, one or more screen layouts for each display device 116 and one or more screen specifications (i.e., screen designs or windows of a screen layout) for each data source endpoint. Each screen specification may include screen content (i.e., what content is displayed), screen format (i.e., in what format is the content displayed) and a screen layout (i.e., where should the content be presented on the screen). Each display device may have multiple screen layouts and a user may select which screen layout to display at any moment. The AR screen module 350 further contains instructions that when executed by the one or more microprocessors 340, cause the one or more microprocessors to push, to a particular display device, information to be shown on the display device.

The detect device module 210 contains instructions that when executed by the one or more microprocessors 340, cause the one or more microprocessors to implement a device discovery protocol for discovering devices, for example data source endpoint devices, that are operationally connected to the network 114. The device awareness module 211 contains instructions that when executed by the one or more microprocessors 340, cause the one or more microprocessors to generate and maintain a list of devices, e.g. data source endpoint devices and display devices, as well as other data source endpoints that are operationally connected to the network 114 including device discovered using the device detection module and devices that are discovered using other methods, for example by receiving a message identified as originating from a previously unknown device or data source.

As shown in FIG. 3B, the EUD (or facilitator device) 119 includes a first network interface 311, a second network interface 321, a memory 331, and a processor 341, which are substantially similar to and configured similarly to first and second network interfaces 310, 320, memory 330, and processor 341 of the SaS AR compute platform 119 (see FIG. 2A). The EUD 119 includes a user configuration app 103. The user configuration app 103 includes an instance of each of a SaS API service, device detect module 210, and device awareness module 211, which are substantially similar to corresponding modules of the SaS AR compute platform 118. The user configuration app 103 further includes a VAS menu module 220, a device settings module 222, and a user interface module 224.

The VAS menu module 220 contains instructions that when executed by the one or more microprocessors 340, cause the one or more microprocessors to generate one or more menus for display on a display device. Information included in the one or menus may include menu definition information encoded in one or more device profiles 113 provided by an endpoint device, e.g., 110 or 112, or by a third-party configuration data source 250.

The device settings module 222 contains instructions that when executed by the one or more microprocessors 340, cause the one or more microprocessors to process device settings definition information contained in one or more device profiles 113, for example to associate menu items with user controllable device settings and corresponding device commands and to extract non-controllable device settings information, for example information regarding a video data source video resolution and frame rate.

The user interface module 224 contains instructions that when executed by the one or more microprocessors 340, cause the one or more microprocessors to provide a user with an interface for interacting with the EUD 119 to select, configure, and change one or more settings, for example one or more screen layouts, selection of data sources, and configuration of hot buttons.

In some embodiments, the SaS AR compute platform 118 includes one or more of a VAS menu module 220, a device settings module 222, and a user interface module 224 and the SaS AR service 115 can be configured to perform one or more of the functions enabled thereby. For example, in some embodiments, the SaS AR service 115 can be operated without a need to interact with a separate user configuration app 103. In a particular exemplary embodiment, for example in an alternative embodiment of a system that does not include an EUD but that includes at least one user input device, for example a button interface or a microphone, and at least one computer-to-human interface, for example a HUD screen or a speaker, an instance of the VAS menu module 220 is included in the SaS AR compute platform 118. A user may interact with the user input device, for example by pressing a button or speaking into the microphone (following which speech may be translated into a command by a component of the system) to generate a command that is mapped to presenting a menu to the user. The VAS menu module 220 receives an indication that the user input device has been actuated (or a command based on the actuation) and, in response, presents one or more menu items on the computer-to-human interface, for example a visual menu on a screen or an audible menu via the speaker.

As noted, the system 100 may include one or more display devices 116 (e.g., heads up display, night vision goggles, wrist worn display, watch, EUD) and each display device may have a different configuration (e.g., screen dimensions, screen layout). As such, the end user may define/select the screen layout for each display device. The user may operate a controller (buttons on helmet, or an app, or a scroll wheel on a watch, etc.) to go to the next screen layout or previous screen layout. In embodiments, changing to a next screen layout or jumping to a particular screen layout may be triggered by events, for example when a user navigates to a new location, a sensor detects that a remote weapon has been fired, or a sensor detects that the user's own weapon has been fired. A change in screen layout may also be triggered by data received by the SaS AR compute platform 118 from an external source on the network 114, based on information received from an ATAK jump plugin (e.g., to automatically change screen layouts at a pre-defined distance from the ground) or based on a user's speed, in examples.

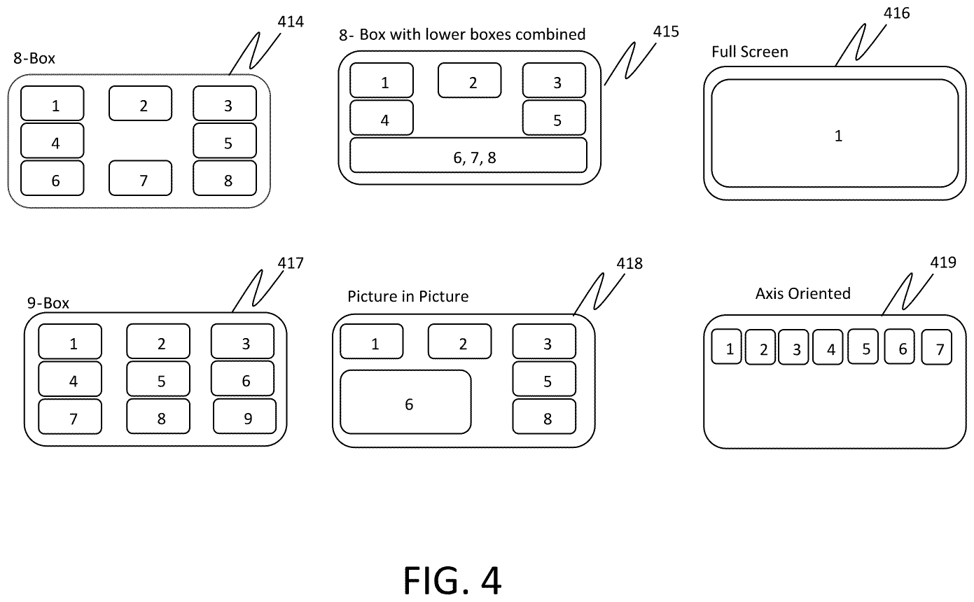

The screen layout may be defined by the number of positions (screen regions or windows) where data may be placed, location of each screen region, and the size of each screen region. The screen layout may be defined using a predefined screen layout, as shown in FIG. 4, or the screen layout may be customized. The predefined screen layouts include a number of options and additional options may be added at any time. Some options are illustrated in FIG. 4 including an 8-box 414, an 8-box with lower boxes combined 415, a full screen 416, a 9-box 417, a 6-box including a picture in picture 418, and an axis oriented 419. Each box is understood to mean a screen region.

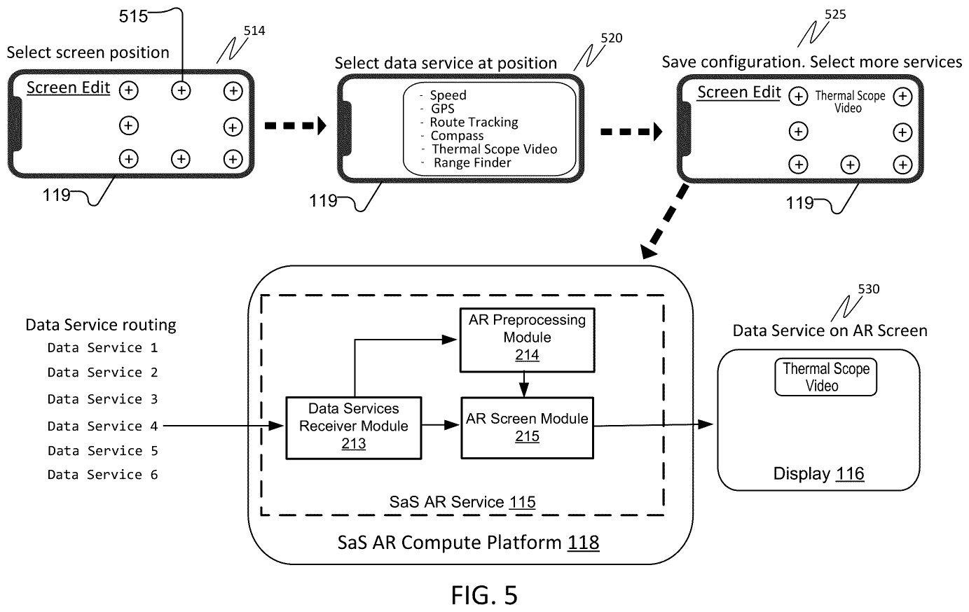

The screen content may be defined by identifying one or more data services which can be provided at each screen region and the source of the data providing the service (i.e., data source endpoint). For example, turning to FIG. 5, in an example embodiment, a user interacts with EUD 119, for example with an instance of the user configuration app 103 that is operating on the EUD (see, for example, FIGS. 2A and 3B) to configure a screen layout. An 8-box screen layout 514 has been selected, and thermal scope video service 520 has been selected for display at position 525 of the first row. The data service route identifies the source of the data (i.e., a particular data service 117 on a data source endpoint), which in this instance is a video data service (data service 4) on a thermal scope device.

The SaS AR service 115, operating on the SaS AR compute platform 118, includes data services receiver module 213 for receiving video data from the video data service and AR screen module 215 for formatting the video data for display on the display device 116 according to the screen layout that the user has defined. The AR preprocessing module 214 may optionally be used, in some implementations, to modify the video data, for example to correct for artifacts. The SaS AR compute platform 118 communicates the formatted thermal scope video content to the display device 116. The display device 116 (e.g., heads up display) will present a screen 530 with the thermal scope video content shown at the selected screen position.

The content provided by each data service may be displayed at one or more corresponding screen regions using a widget. In some embodiments, the SAS AR compute platform 118 assigns a widget for the data service. In some embodiments, the end user may choose one or more widgets for each data service. The widgets may provide displays for a variety of services including scroll bars, menus, icons, drop-down, pop-ups, soft input buttons, maps, video, text, image, etc.

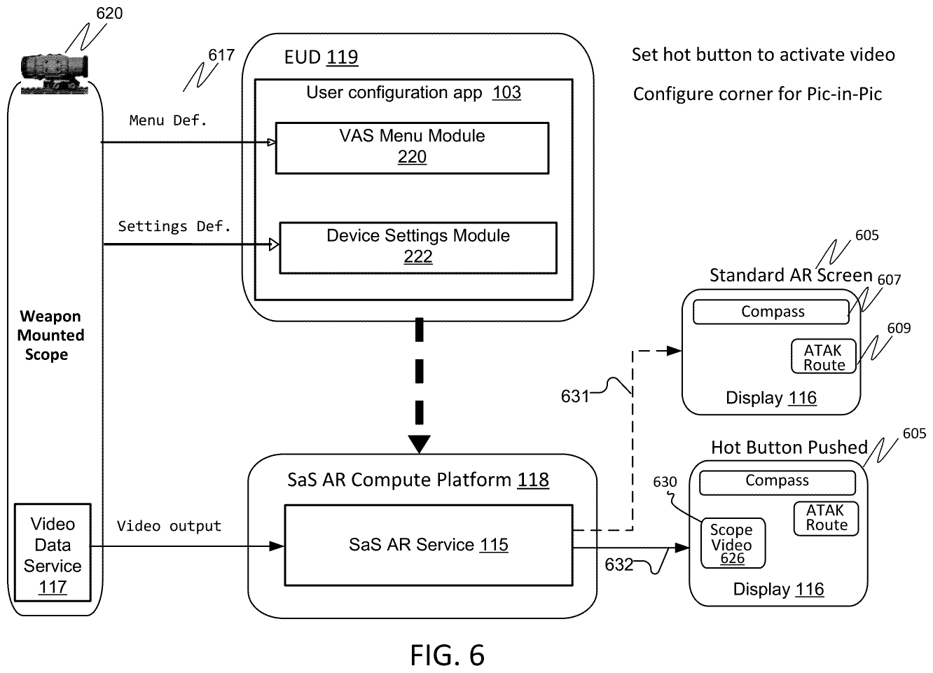

In some embodiments, the screen content may include data sourced from one or more data source endpoints (e.g., 110, 112) and may be displayed collectively on the display. For example, turning to FIG. 6, screen 605 displays compass data content 607 and ATAK route data content 609. In this instance, weapon mounted scope 620 is a data source endpoint which is integrated with system 100.

In some embodiments, a data source endpoint may include one or more system menu selections 617, such as, for example, a settings definition containing video settings for a thermal scope device and a menu definition for the thermal scope device. These may be encoded in one or more configuration profiles 113 (see FIG. 2A). In some embodiments, the EUD 119 communicates with the data source endpoint device to receive one or more system menu selections 617 including menu definitions and setting definitions. Menu definitions, for example, define information to be displayed on a user-selectable menu corresponding to the endpoint device when a user presses a menu button. Settings definitions define one or more user configurable or non-configurable settings corresponding to the endpoint device, for example a scope screen brightness and a resolution (e.g., in DPI) of a video feed available from a video data service of the endpoint device. The EUD may communicate the settings information and one or more screen specifications, including screen layouts selected by a user through operation of the user configuration app 103, to the SaS compute platform 118. In other embodiments, the SaS compute platform 118 may receive the system menu selections 617 (and configuration profiles) directly from the endpoint device (e.g., from the thermal scope).

Further, referring to FIG. 6, the SaS AR compute module 118 controls, as indicated by a dashed line arrow 631, a display device 116, for example a HUD, to display a standard AR screen 605 that includes compass information shown in a first window 607 and ATAK route information displayed in a second window 609.

When a user pushes a hot button, for example a button on the scope 620 or a button on another device connected to the network, the SaS AR compute module 118 controls, as indicated by solid arrow 632, the display device 116 to add, to the standard AR screen, a window for showing information, e.g. a video content, provided by a weapon mounted scope 620 and the window is generated to display the video content 626 at position 630 on the display screen 605. Further, the screen region of position 630 on the display screen is set as pic-in-pic, which provides a video stream 626 playing within an inset window. In a non-limiting embodiment, the weapon mounted scope 620 has a hot button integrated in its structure which is intended to activate video. Hence, the screen design also may define activation of a hot button as a trigger to start displaying the video content 626.

In the embodiment shown in FIG. 6, scope video data 626 is communicated from the scope 620, to the SaS AR compute platform 118, and from there to the display 116, for example to a HUD. However, the inventive concepts disclosed herein are not so limited. For example, the SaS AR compute platform 118 can communicate, to the scope 620, information to be displayed on a display screen of the scope, for example information generated by a weapons controller of the system 100. In still further embodiments, the SaS AR compute platform 118, or another system device, for example EUD 119, can receive network data and direct the network data to an app running on, for example, the AR compute platform 118 or the EUD 119. The app, in turn, can generate information for display on the display device 116. For example, a location app running on the EUD 119 can receive GPS data from a GPS transceiver (not shown), generate location information based on the GPS data, and communicate the location information to the SaS AR compute platform 118 which causes the location information to be shown on the display device (e.g., HUD) 116.

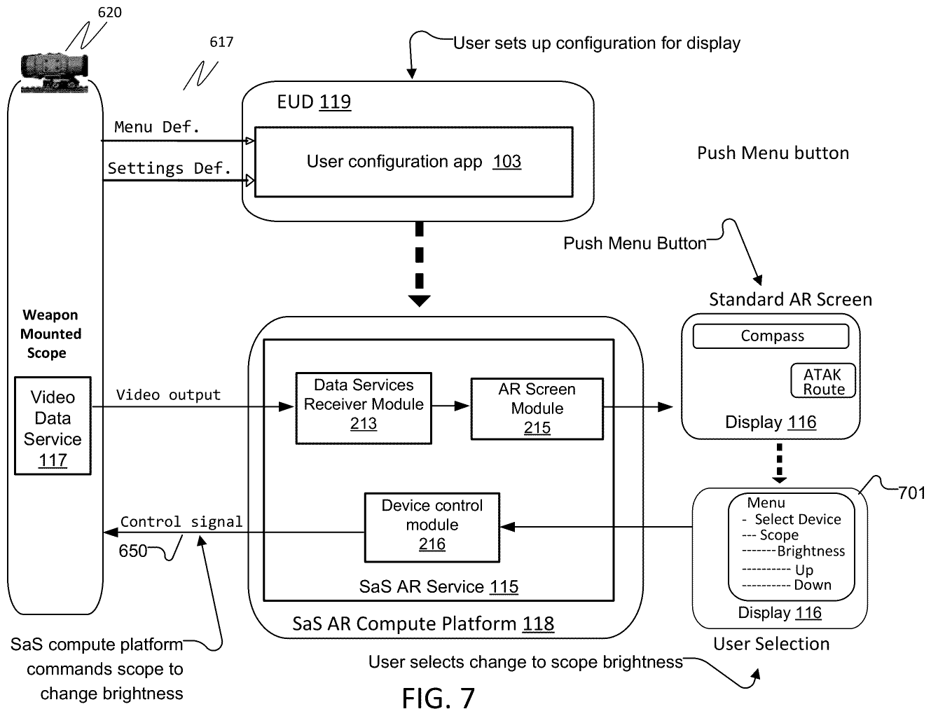

In some embodiments, the screen design for a data source endpoint may include a custom menu 701, as shown in FIG. 7, which may be presented to an end user via display 116 to manage one or more device settings for the data source endpoint. The information to be displayed on the menu 701 may be encoded in as menu definition of a configuration profile 113 that is either communicated to the SaS AR compute platform 118 directly by an endpoint device via an API-compliant provisioning process (see FIG. 2A) or to the SaS AR compute platform 118 from an EUD or other facilitator 119 via a non-API provisioning process or a hybrid provisioning process (see FIG. 2B). Further, the screen design may define the menu as a push button menu including a touch panel which allows the user to make selections using the touch panel. The system 100 may dynamically generate menu options based on one or more of: menu definitions/configuration profiles 113; the content displayed in the screen; and other options that may apply regardless of what is currently displayed.

A user may interact with the displayed menu 701, for example using a keypad or other user interface device, to select a menu option, for example to select a change in scope screen brightness. In response to the selection, the device control module 216 of the SaS AR service 115 generates one or more control signals 650. The one or more control signals 650 are communicated by the SaS AR compute platform 118 to the scope 620 and the scope, in response to the one or more control signals 650 alters and operational state, for example by increasing or decreasing a brightness of a scope display screen. In some embodiments, the SaS AR service 115, and in particular the device control module 216, generates control signals, e.g., 650, for one or more endpoint devices based at least in part upon configuration information, e.g., device settings information, that was previously communicated to the SaS AR compute platform 118, for example as at least a portion of a configuration profile 113 (see FIGS. 2A, 2B).

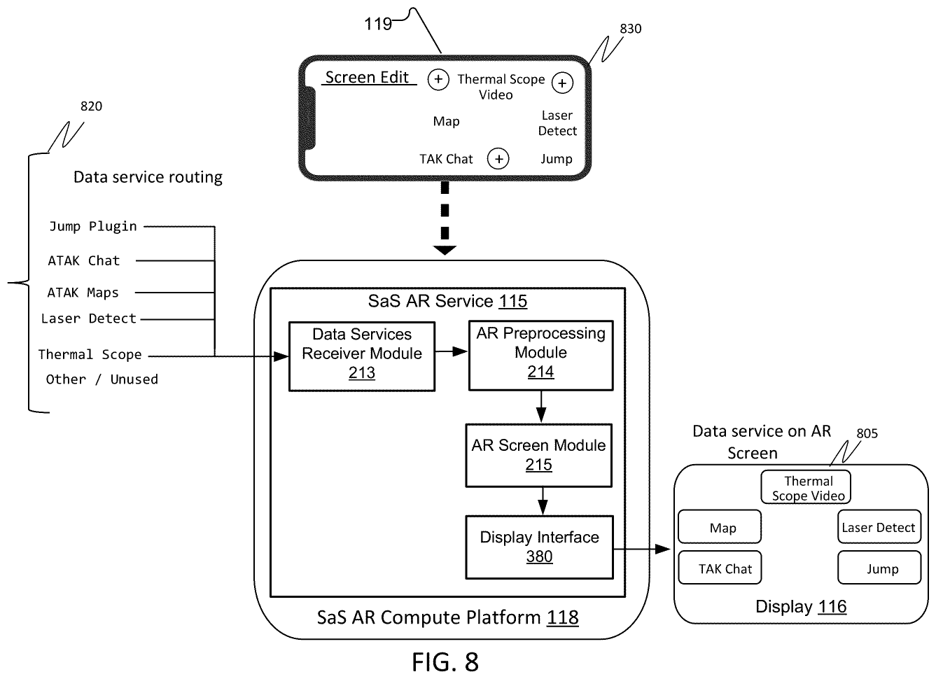

FIG. 8 illustrates another example of a screen including screen content sourced from multiple data source endpoints 820 which are collectively displayed on screen 805. The screen will be shown on display device 116 having screen layout 830 that is defined by user interacting with the EUD 119 to control the user interface app 103 operating thereupon, as previously discussed.

AR preprocessing module 214 and AR screen module 215 in SaS AR service 115 together contain instructions that when executed by the one or more microprocessors 340, cause the one or more microprocessors to collect the data received at the first and second network interfaces 310, 320 and processed by the data services module 213, extract relevant information from the data and convert it into a format suitable for display on display device 116 consistent with the screen design for each data source endpoint providing the data. This processing may include calculations, formatting, and converting numerical values into graphical elements.

As previously discussed, device detection module 210 in SaS AR services 115 contains instructions that when executed by the one or more microprocessors 340, cause the one or more microprocessors to discover data source endpoints connected to network 114 using a discovery protocol, such as, for example, service discovery protocol (SDP), simple service discovery protocol (SSDP), universal plug n play (UPnP), service location protocol (SLP), universal discovery description and integration (UDDI), secure persuasive discovery protocol (SPDP), etc.

The discovery protocol allows the SAS AR compute platform 118 to obtain configuration and device settings for the discovered data source endpoint. For example, using a discovery protocol, the device detection module may send an inquiry to the discovered data source endpoint requesting whether it is enabled for one or more services, such as, for example, screen as a service (SaS).

In some embodiments, the asynchronous integration process occurs when the data source endpoint device is detected via the discovery protocol.

Display interface 380 receives the processed data from AR screen module 210 and converts the data into graphical elements such as text, icons, symbols, graphics, video, etc. Thereafter, the converted data is sent to display 116. Further, the display interface provides updates to display 116 in real time as new data is collected and processed. This ensures that the displayed information remains current and relevant to the user's situation.

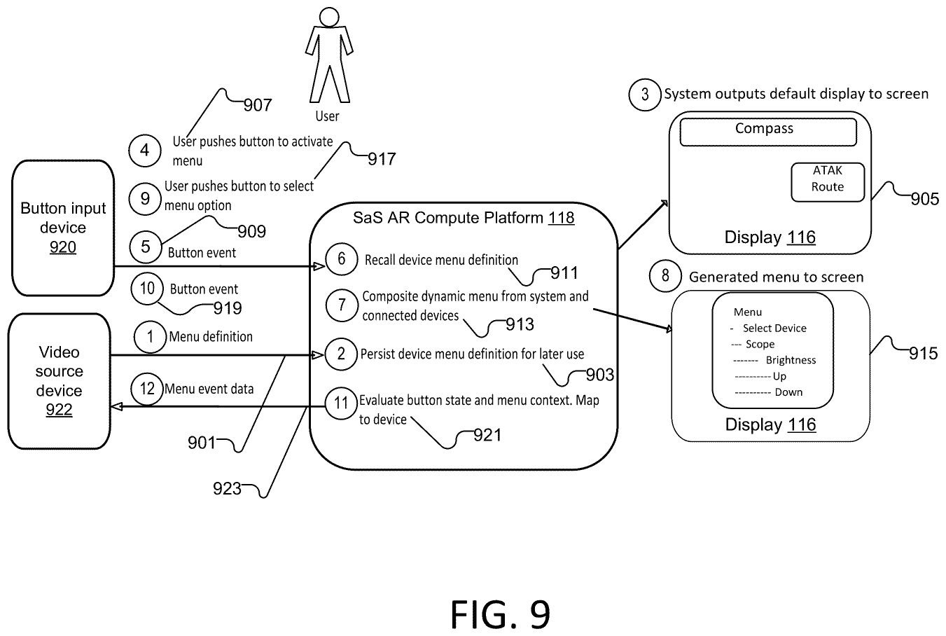

FIG. 9 illustrates an exemplary data flow 900 for a screen as a service platform in accordance with exemplary embodiments of the present disclosure. According to an exemplary embodiment of the present disclosure, the SAS AR compute platform 118 may receive menu definitions, e.g., in one or more configuration profiles 113, at flow 901 from a data source endpoint 110, 112. In response to receipt of the menu definitions, the SAS AR compute platform 118 may store the device menu definitions in persistent memory for later use at flow 903. When data is received from the data source endpoint, the SAS AR compute platform 118 outputs the one or more screens, or one or more windows on a screen, generated for the corresponding data source endpoint at flow 905.

Further, the SAS AR compute platform 118 may receive a device setting/data service for the data source endpoint which identifies an input source 920 (e.g., a push button) to activate a menu at flow 907. In response to receiving an input from the push button at flows 909, the SAS AR compute platform may recall the device menu definition from the persistent memory and composite a dynamic menu from the system and connected devices at flows 911-913. At flow 915, the SAS AR compute platform displays the generated menu on display 116.

At flows 917-919, a user pushes the push button to select a menu option. In response to receipt of the push button input (i.e., button event), the SAS AR compute platform 118 evaluates the button state and menu context and maps the event to a corresponding data source endpoint at flow 921. At flow 923, the SAS AR compute platform 118 transmits the menu event data to the data source endpoint.

Further, when the SAS AR compute platform 118 receives data from a data source endpoint, the SAS AR compute platform 118 retrieves one or more screens from the data store in SAS AR compute platform or facilitator 119 corresponding to the data source endpoint and displays the content on display 116 via the one or more generated screens.

In some embodiments, the SAS AR compute platform 118 receives an input from a user indicating which display device(s) should display the data. In response to the input, the SAS AR compute platform retrieves the one or more screen layouts for each display in addition to the one or more screens generated for a corresponding data source endpoint and displays data in a manner consistent with both the display device(s) and the corresponding data source endpoint.

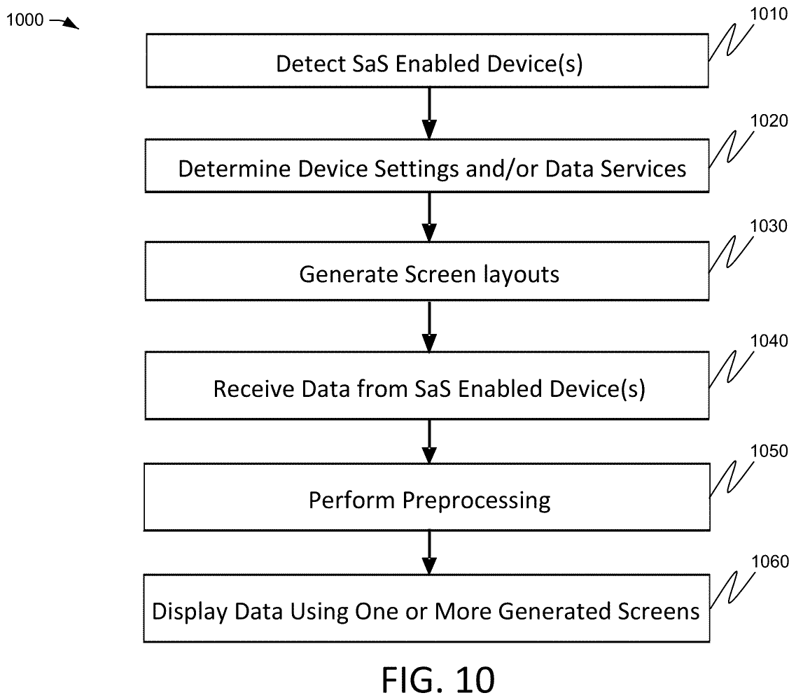

Turning to FIG. 10, the steps described in flow diagram 1000 describe exemplary functions performed by the SAS AR compute platform 118. The SAS AR compute platform detects one or more SAS enabled end-point devices connected to the at least one network at step 1010 using device detection module 380. As noted above, the discovery protocol used in the device detection module allows the SAS AR compute platform 118 to obtain configuration and device settings data from the discovered device (i.e., data source endpoint). The configuration and device settings data may include device identification information, one or more transport protocols used by the component, data routing rules, location/port number, data syntax/format, whether the data source endpoint is SaS-enabled, whether the component is compliant with a known or proprietary middleware messaging system, data routing rules, etc.

At step 1020, the SAS AR compute platform 118 determines one or more device settings and/or one or data services offered or accepted by the data source endpoint.

At step 1030, the SAS AR compute platform generates one or more screens for the data source endpoint based on the determined one or more device settings and/or one or more data services offered and/or accepted by the integrated endpoint device. In some embodiments, the generated one or more screens are stored in a data store in SAS AR compute platform 118. In some embodiments, the generated one or more screens are stored in a data store in facilitator 119. In some embodiments, the one or more generated screens are stored in a data store in both the SAS AR compute platform and the facilitator.

At step 1040, the SAS AR compute platform receives data from the SaS enabled device. In some embodiments, the received data is collected and stored in memory 330.

At step 1050, the SAS AR compute platform 118 performs preprocessing on the data and/or the display. In some embodiments, the SAS AR compute platform preprocesses the display by removing visual elements from the screen layout for any data source endpoint or data not available.

At step 1060, the SAS AR compute platform 118 displays one or more of the screens generated for the corresponding data source endpoint including the data received from a corresponding data source endpoint on display 116.

Although disclosed embodiments describe a screen as a service platform, the system may be used without a screen. In fact, the system may be implemented using any suitable human-to-machine interface, e.g. any input/output device or devices that are capable of exchanging inputs and outputs between a user and a compute module; for example, the system may send data audibly to a headset or speaker and may receive user input data from a microphone.

Moreover, in some embodiments, the SAS AR compute platform 118 may process data and wait for a data source endpoint 110, 112 or a facilitator 119 to be connected. A user may also swap screens between a daytime display and a night vision display.

It will also be recognized by those skilled in the art that, while the technology has been described above in terms of preferred embodiments, it is not limited thereto. Various features and aspects of the above-described technology may be used individually or jointly. Further, although the technology has been described in the context of its implementation in a particular environment, and for particular applications those skilled in the art will recognize that its usefulness is not limited thereto and that the present technology can be beneficially utilized in any number of environments and implementations, such as, for example, include 1) route tracking by getting direction and time to next waypoint, 2) showing an overall route on a map, 3) geolocation data on a map or compass, 4) any form of data being received over networks, 5) chat messages, 6) alert messages from sensors such as a laser sensor, 7) sensor readings from a chemical sensor, 8) messages that guide a jumper during freefall, 8) timed events, such as when to open a parachute or coordinating event across a team. Accordingly, the claims set forth below should be construed in view of the full breadth and spirit of the technology as disclosed herein.

It is also noted that although the subject technology of this disclosure is described herein primarily in relation to providing visual information to a user on one or more display devices, the technology disclosed herein it not so limited. One skilled in the art will readily understand that the same inventive concepts and principles described herein in relation to displaying visual information are also applicable to many other information presentation modalities, for example and not limited to audio information communicated to a user with one or more speakers and tactile feedback information communicated to a user with one or more haptic output devices, for example various buzzers, vibrators, or thermal haptic feedback devices to provide haptic feedback that can include, for example, vibrotactile feedback, force feedback, electro-tactile feedback, ultrasonic tactile feedback, and thermal feedback.

According to exemplary embodiments the functional operations described herein can be provided in digital electronic circuitry, or in computer software, firmware, or hardware, including the structures disclosed in this specification and their structural equivalents, or in combinations of one or more of them. Some embodiments of the subject matter of this disclosure, and components thereof, can be realized by software instructions that upon execution cause one or more processing devices to carry out processes and functions described above. Further embodiments of the subject matter described in this specification can be implemented as one or more computer program products, i.e., one or more modules of computer program instructions encoded on a tangible program carrier for execution by, or to control the operation of, data processing apparatus.

One or more exemplary computer programs (also known as a program, software, software application, script, or code) for executing the functions of the exemplary embodiments disclosed herein, can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

In some embodiments, the processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be, in some embodiments, an apparatus or device embodying the technology in the form of a gateway, an access point, a set-top box or other standalone device, or may be incorporated in a television or other content playing apparatus, or other device, and the scope of the present technology is not intended to be limited with respect to such forms.

Components of some embodiments may be implemented as Integrated Circuits (IC), Application-Specific Integrated Circuits (ASIC), or Large-Scale Integrated circuits (LSI), system LSI, super LSI, or ultra LSI components. Each of the processing units can be many single-function components or can be one component integrated using the technologies described above. Components may also be implemented as a specifically programmed general purpose processor, CPU, a specialized microprocessor such as Digital Signal Processor that can be directed by program instructions, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

It is also contemplated that implementations and components of embodiments can be done with any newly arising technology that may replace any of the above implementation technologies.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, where operations are depicted in the drawings in a particular order, this should not be understood as requiring that such operations be performed in the particular order shown or in sequential order unless otherwise noted, or that all illustrated operations be performed, to achieve desirable results. In certain circumstances, multitasking and parallel processing may be advantageous. For example, a SaS AR compute platform 118 may offload processing of information to another system, for example to an EUD 119, or another processor of one a network, for example onto a processor of a smart hub when the SaS AR compute platform 118 is implemented on a processor of a smart helmet. Moreover, the separation of various system components in the embodiments described above should not be understood as requiring such separation in all embodiments, and it should be understood that the described program components and systems can generally be integrated together in a single software product or packaged into multiple software products.

While the preceding discussion used USB, ISW Wi-Fi, Bluetooth, and other wireless protocols as illustrative examples, in other embodiments a wide variety of communication protocols and, more generally, adaptive balancing techniques may be used. Thus, the adaptive balancing technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the adaptive balancing technique may be implemented using program instructions, operating system (such as a driver for interface circuit) or in firmware in an interface circuit. Alternatively, or additionally, at least some of the operations in the adaptive balancing technique may be implemented in a physical layer, such as hardware in an interface circuit.

In the preceding description, we refer to ‘some embodiments.’ Note that ‘some embodiments’ describes a subset of all of the possible embodiments but does not always specify the same subset of embodiments. Moreover, note that numerical values in the preceding embodiments are illustrative examples of some embodiments. In other embodiments of the communication technique, different numerical values may be used.

The foregoing description is intended to enable any person skilled in the art to make and use the disclosure and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown but is to be accorded the widest scope consistent with the principles and features disclosed herein.

Having described the technology in detail, it will be understood that such detail need not be strictly adhered to, but that additional changes and modifications may suggest themselves to one skilled in the art.

What is claimed:

1. A system for providing a screen as a service platform comprising:
at least one display device;
at least one network;
a screen as a service platform comprising:
at least one device interface that is communicatively coupled to the at least one display device, the at least one network and one or more endpoint devices;
at least one processor; and
at least one memory having stored thereon a screen as a service (SaS) application including a plurality of machine executable instructions that when executed by the at least one processor, cause the processor to:
detect an endpoint device which is communicatively connected to the at least one network;
determine one or more device settings for each integrated endpoint device and one or more data services offered and/or accepted by the integrated endpoint device,
generate one or more screen designs based on the determined one or more device settings and/or one or more data services offered and/or accepted by the integrated endpoint device;
receive data from the one or more integrated endpoint devices; and
display, in response to receipt of data from the one or more integrated endpoint devices, the received data on the at least one display device in accordance with the one or more screen designs.

2. The system of claim 1 wherein the machine executable instructions further cause the processor to integrate the detected endpoint device into the system if the device is SaS enabled.

3. The system of claim 2 wherein the detected endpoint device is integrated into the system asynchronously.

4. The system of claim 1 wherein the machine executable instructions further cause the processor to create one or more screen layouts for the at least one display device.

5. The system of claim 1 wherein the machine executable instructions further cause the processor to:
collect data received from the one or more SaS enabled end-point devices; and
perform preprocessing on the at least one display device.

6. The system of claim 1 wherein the system further comprising a plurality of display devices.

7. The system of claim 6 wherein the machine executable instructions further cause the processor to display the received data concurrently on the plurality of display devices.

8. The system of claim 5 wherein preprocessing the at least one display device includes removing visual elements from the screen layout for any data source endpoint or data not available.

9. The system of claim 1 wherein the one or more screen designs define a screen layout, screen content and screen format.

10. The system of claim 1, wherein the machine executable instructions further cause the processor to:
aggregate data from multiple data source endpoints; and
determine how to display the aggregated data one or more screens.

11. The system of claim 10, wherein the multiple data source endpoints comprise one or more of a local network device, a remote networked data source, or software installed on a local network device.

12. The system of claim 1 wherein the machine executable instructions further cause the processor to integrate the detected endpoint device into the system if configuration information corresponding to the device is pre-programmed in a data-store or endpoint adapter of the system.

13. The system of claim 1 wherein the at least one display device is a wearable device.

14. The system of claim 1 wherein the at least one display device is a heads-up display.

15. The system of claim 1 wherein the at least one display device is a night goggle device.

16. The system of claim 1 wherein the at least one display device is a wrist worn display device.

17. A system comprising:
at least one human-machine interface device;
at least one network;
a human-machine interface platform comprising:
at least one device interface that is communicatively coupled to the at least one human-machine interface device, the at least one network and one or more endpoint devices;
at least one processor;
at least one memory having stored thereon an application including a plurality of machine executable instructions that when executed by the at least one processor, cause the processor to:
detect one or endpoint devices which are communicatively connected to the at least one network;
determine one or more data services offered by the one or more endpoint devices;
generate one or more human-machine interface communication layouts based on the one or more data services offered by the one or more endpoint devices;
receive data from the one or more endpoint devices; and
communicate, in response to receipt of data from the one or more endpoint devices, information to a user based upon the received data and corresponding to the one or more human-machine interface communication layouts.

18. The system of claim 17, wherein the human-machine interface device comprises a screen for displaying visual information.

19. The system of claim 18, wherein the one or more human-machine interface communication layouts comprise a display screen layout specifying placement and display parameters for display of visual data on the screen.

20. The system of claim 17, wherein the human-machine interface device is configured to provide one or more of audio, video, and haptic feedback information to a user of the system.

21. A new system substantially as disclosed herein.
